(19) United States
(12) Patent Application Publication
(10) Pub. No.: US 2009/0064334 A1
(43) Pub. Date: Mar. 5, 2009

(54) Adaptive Autonomic Threat Detection and Quarantine

(75) Inventor: Justin Heath Holcomb, Durham, NC (US)

Correspondence Address: STEVENS & SHOWALTER, L.L.P., BOX IBM, 7019 CORPORATE WAY, DAYTON, OH, 45459-4238, US

(73) Assignee: INTERNATIONAL BUSINESS MACHINES CORPORATION, Armonk, NY (US)

(21) Appl. No.: 11/847,823

(22) Filed: Aug. 30, 2007

(51) Int. Cl. G06F 11/30

(52) U.S. Cl. 726/24

(57) ABSTRACT

Autonomic threat detection is performed by collecting traffic samples of traffic patterns associated with a networked device having a device resident validation module. A threat analysis system is used to recognize a pattern of traffic indicative of a compromised device based at least in part upon the traffic samples. If the samples indicate a compromised device, the device is quarantined and a security check is performed on the device. The security check may include requesting data from the corresponding device resident validation module to determine if the device is compromised, analyzing data from the device resident validation module of the quarantined device and taking an action based upon analysis of the data. At least one of the data from the device resident validation module of the quarantined device or the traffic samples is utilized to autonomically train the threat analysis system to identify compromised devices.

### BACKGROUND OF THE INVENTION

The present invention relates to systems, computer-implemented methods and computer program products for performing adaptive autonomic threat detection and quarantine of detected threats.

In a network computing environment, connected devices that are infected by worms, Trojans, spyware and other forms of malware impose burdens on network resources and create additional challenges for network administrators. For example, certain malware may pose a nuisance to the computing environment, e.g., by causing system slowdowns. Other forms of malware may lead to the loss or corruption of information stored within the computing environment. Still further, devices that are logged into or otherwise connected to the computing environment may create problems for network administrators when controlled by malicious users with ill intent, e.g., to misappropriate information, which may be used for nefarious purposes such as identity theft.

In addition to the potential for infection of other devices connected to the computing environment, data corruption and data theft, infected devices can often consume enormous amounts of network bandwidth through port-scanning or sending mass emails. The problems created by a malware infected computing environment are magnified in the context of mobile computing since mobile computing devices often connect into an intranet through unsecured public networks and are thus potentially exposed to malicious traffic from untrusted devices on these unsecured public networks.

There are several techniques that may be used to detect infected devices and to curtail activity caused by malware. For example, devices may be required to successfully pass a validation test prior to logging into a corresponding computing environment. However, conventional validation tests typically require a lengthy validation process, e.g., by running virus scans on every connection. Validation tests are also not optimal because typical validation tests cannot respond in real-time if a device becomes compromised by malware after it has been connected to the network. Another exemplary approach to curtail activity caused by malware is to define static heuristics in the form of statistical roles and attempt to use these heuristics to detect and disconnect compromised devices in real-time. However, conventional statistical heuristics approaches rely on information determined from an analysis of previous traffic and attack patterns, thus the heuristics may be invalid for new patterns of attacks.

### BRIEF SUMMARY OF THE INVENTION

According to various aspects of the present invention, methods, computer program products and systems are provided for performing autonomic threat detection. Autonomic threat detection is performed by collecting traffic samples of traffic patterns associated with a device having a device resident validation module, which is connected to a network. Autonomic threat detection is further performed by using a threat analysis system to recognize a pattern of traffic determined to be indicative of a compromised device, based at least in part upon the traffic samples. If the samples indicate a compromised device, the device is quarantined and a security check is performed on the device.

If the device has been quarantined, the security check is performed by requesting data from the corresponding device resident validation module to determine if the device is compromised, analyzing data from the device resident validation module of the quarantined device and taking an action based upon analysis of the data. Autonomic threat detection is further performed by utilizing at least one of the data from the device resident validation module of the quarantined device or the traffic samples to autonomically train the threat analysis system to identify compromised devices.

### BRIEF DESCRIPTION OF THE SEVERAL VIEWS OF THE DRAWINGS

FIG. 1 is a schematic illustration of an exemplary system that may be utilized to implement autonomic threat detection according to various aspects of the present invention;

FIG. 2 is a flow chart illustrating a method of performing autonomic threat detection according to various aspects of the present invention;

FIG. 3 is a block diagram of a threat detection system that may be used to implement the method of FIG. 2, according to various aspects of the present invention;

FIG. 4 is a flow chart illustrating aspects of autonomic threat detection according to various aspects of the present invention;

FIG. 5 is a flow chart illustrating aspects of autonomic threat detection according to various aspects of the present invention;

FIG. 6 is a flow chart illustrating aspects of autonomic threat detection according to various aspects of the present invention;

FIG. 7 is a flow chart illustrating aspects of autonomic threat detection according to various aspects of the present invention; and

FIG. 8 is a block diagram of an exemplary computer system including a computer usable medium having computer usable program code embodied therewith, where the exemplary computer system is capable of executing a computer program product to provide autonomic threat detection and quarantine of detected threats and/or to provide device resident security validation according to various aspects of the present invention.

### DETAILED DESCRIPTION OF THE INVENTION

According to various aspects of the present invention, autonomic adaptive threat detection and quarantine of detected threats is implemented in a network computing environment. A threat detection system analyzes network connections to detect connected devices that may be compromised, e.g., devices that are believed to be infected by malware or devices that are believed to be used for malicious or otherwise inappropriate purposes. The threat detection system quarantines devices believed to be compromised, then resolves whether the quarantined device is actually a threat through interaction with a device resident security validation component provided on each quarantined device. Based upon the interaction with quarantined devices, the threat detection system autonomically trains itself to adapt to changing threat conditions, as will be described in greater detail herein.

The threat detection system according to various aspects of the present invention provides a layer of protection for the network environment against compromised devices and may be used in conjunction with, or as an alternative to conventional threat detection methods.

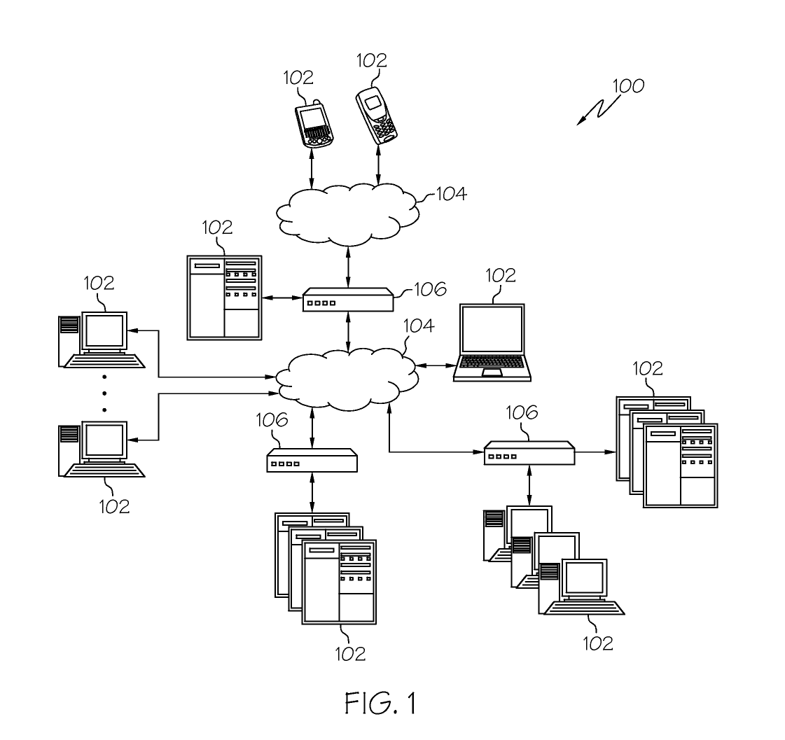

Referring now to the drawings and particularly to FIG. 1, a general diagram of a network computing environment 100 is illustrated. The computing environment 100 comprises a plurality hardware and/or software processing devices 102 that are linked together by a network 104. Typical processing devices 102 may include servers, personal computers, notebook computers, transactional systems, purpose-driven appliances, pervasive computing devices such as a personal data assistant (PDA), palm computers, cellular access processing devices, special purpose computing devices, printing and imaging devices, facsimile devices, storage devices and/or other devices capable of communicating over the network 104. The processing devices 102 may also comprise software, including applications and servers that interact with various databases, spreadsheets, structured documents, unstructured documents and/or other files containing information.

The network 104 provides communications links between the various processing devices 102, and may be supported by networking components 106 that interconnect the processing devices 102, including for example, routers, hubs, firewalls, network interfaces wired or wireless communications links and corresponding interconnections. Moreover, the network 104 may comprise connections using one or more intranets, extranets, local area networks (LAN), wide area networks (WAN), wireless networks (WIFI), the internet, including the world wide web, and/or other arrangements for enabling communication between the processing devices 102, in either real time or otherwise, e.g., via time shifting, batch processing, etc. The network 104 is shown by way of illustration, and not by way of limitation, as a computing environment in which various aspects of the present invention may be practiced.

It is possible that malicious attacks on a network processing system may occur. For example, a network server or other processing device 102 may become infected by malware, which can potentially spread throughout the network, causing a nuisance such as slow downs, spurious email generation and other undesired network activity and/or loss of data. Further, a malicious attack may take the form of a user that is accessing a networked processing device 102 for malicious or otherwise inappropriate purposes, e.g., to commit nefarious acts such as identity theft. As such, threat detection and quarantine of processing devices 102 that are believed to be threats to the network computing environment 100 may be performed.

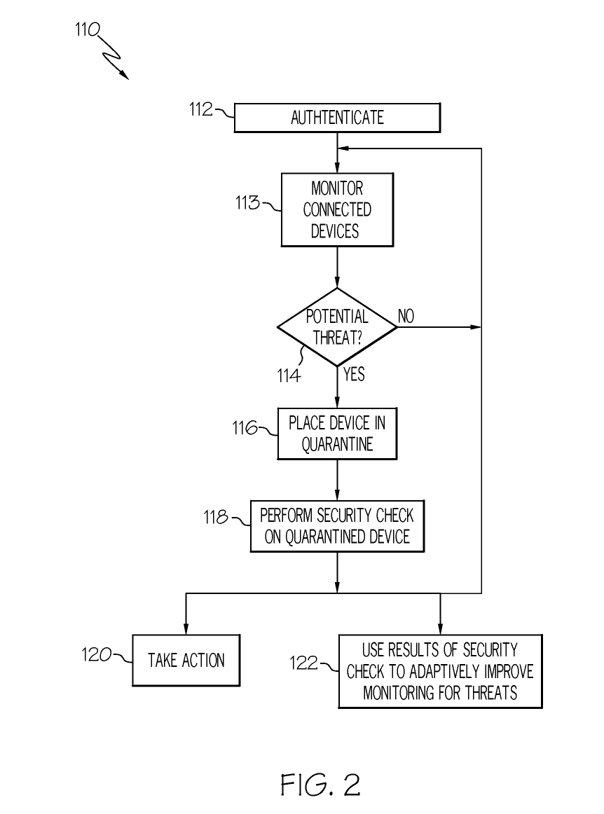

Referring to FIG. 2, a method of performing threat analysis 110 comprises optionally authenticating devices at 112 that wish to connect to the network computing environment. The authentication process at 112, when implemented, may be performed by any appropriate authentication component, including a third party authentication component. The method further comprises monitoring at 113, each connected device in real-time or substantially near real time.

A decision is made at 114 if a monitored device is believed to pose a potential threat to the network computing environment or components thereof. If no potential threat is suspected at 114, monitoring of the connected device(s) continues. If a potential threat is suspected in a connected device at 114, then that connected device that is believed to be a possible threat is placed into quarantine at 116.

A security check is performed at 118 on the quarantined device and an appropriate action is taken as a result of the security check at 120. For example, if the security check results in a conclusion that the quarantined device is not a security risk, then the device may be removed from quarantine. If the quarantined device is determined to be a risk to the network or components thereof, appropriate security measures are taken, examples of which will be described in greater detail herein. The results of the security check are also utilized to adaptively improve the analysis capabilities of monitoring for threats at 122 as will be described in greater detail herein.

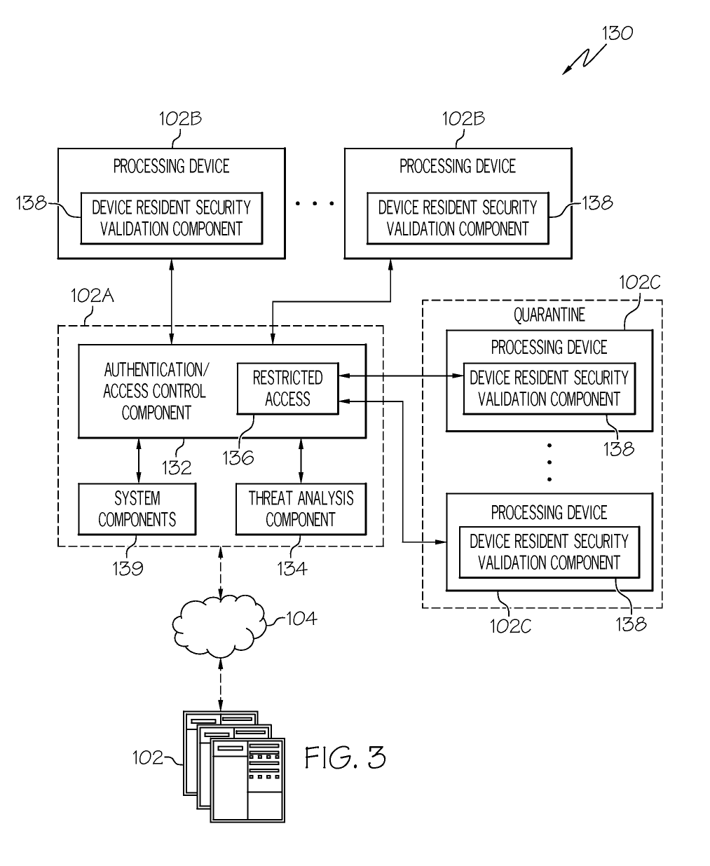

Referring to FIG. 3, a threat detection system 130 for autonomic adaptive threat detection and quarantine of detected threats is illustrated. The system 130 may implement, for example, the method 110 as described with reference to FIG. 2. According to various aspects of the present invention, the system 130 comprises a network server side authentication/access control component 132 and a network server side threat analysis component 134. The authentication/access control component 132 and the threat analysis component 134 are provided on a processing device designated 102A, such as a server connected to the network in the exemplary system illustrated. However, in practice, the authentication/access control component 132 and/or the threat analysis component 134 may be distributed across one or more processing devices associated with the corresponding network, such as one or more of the processing devices 102 shown in FIG. 1.

The authentication/access control component 132 may comprise, for example, a VPN server or other access point to the network computing environment that provides the necessary log-on, user authentication and/or access control as required by the particular implementation of the network computing environment. The authentication/access control component 132 further includes a restriction module 136 to restrict traffic from a specific device, such as by using network filters or other exclusionary techniques as will be described in greater detail herein. The threat analysis component 134 monitors each processing device 102, further designated by the reference numeral 102B, which is connected to the network through the network server side authentication/access control component 132, in real-time. As used herein, the term “real-time” should be interpreted in a practical manner to include substantially near real time, e.g., to account for reasonable propagation and communication delays, threat analysis processing delays, etc.

If a connected processing device 102B is believed to be compromised, the authentication/access control component 132 and the threat analysis component 134 work together to interact with a device resident security validation component 138 provided with the corresponding connected processing device 102B, to implement autonomic threat detection and quarantine of detected threats. In an exemplary implementation, upon suspecting a compromised device, the threat analysis component 134 instructs the authentication/access control component 132 to quarantine the suspected device.

As shown, connected and monitored processing devices that are quarantined are further designated by the reference 102C to differentiate these devices from non-quarantined processing devices 102B. In a quarantined state, traffic to and from a given quarantined processing device 102C is restricted. For example, upon receiving a request from the threat analysis component 134 to quarantine a connected processing device, the authentication/access control component 132 uses its restriction module 136 to prevent the quarantined processing device 102C from communicating with devices 102 and system components 139, which may comprise, devices, processes, servers, databases, storage retrieval systems and other networked components, features, services, etc., which are deployed or otherwise connected to the network computing environment 100.

If a processing device has been quarantined, the associated device resident security validation component 138 performs a security check on its corresponding quarantined device 102C and the results of the security check are fed back into the threat analysis component 134. According to an aspect of the present invention, the device resident security validation component 138 comprises a tamper-resistant, device resident program that has the ability to run a suite of validation tests on the quarantined processing device 102C, which might include such things as a virus scan, verification of firewall rules, and analysis of patch levels.

Based upon the results of the security audit, an action is taken. For example, if the quarantined processing device 102C is found not to be a threat, the device can be released from quarantine, e.g., by turning off the filter or other control component of the restriction module 136. If the quarantined processing device 102C is found to be a threat, the authentication/access control component 132 may disconnect the corresponding quarantined processing device 102C from the network. Another exemplary action may be to attempt to correct, repair, clean or otherwise remedy the quarantined processing device 102C that is believed to be compromised, e.g., by using a suitable virus/repair technique to clean the device. Any other number of reasonable actions may further be taken, in addition to or in lieu of the examples given above. Still further, the results of the security check are used to adaptively improve the analysis capabilities of the threat analysis component 134.

According to various aspects of the present invention, the system can dynamically detect whether a connected processing device 102B has become compromised and block it from accessing other network devices 102 and/or system components 139 in real-time, thus providing enhanced capabilities over the “scan at connect” types of conventional validation. Moreover, according to various aspects of the present invention, the system 130 does not rely solely upon filters making use of heuristic rules because the system can adapt to different types of threats without the intervention of the operator as will be described in greater detail below.

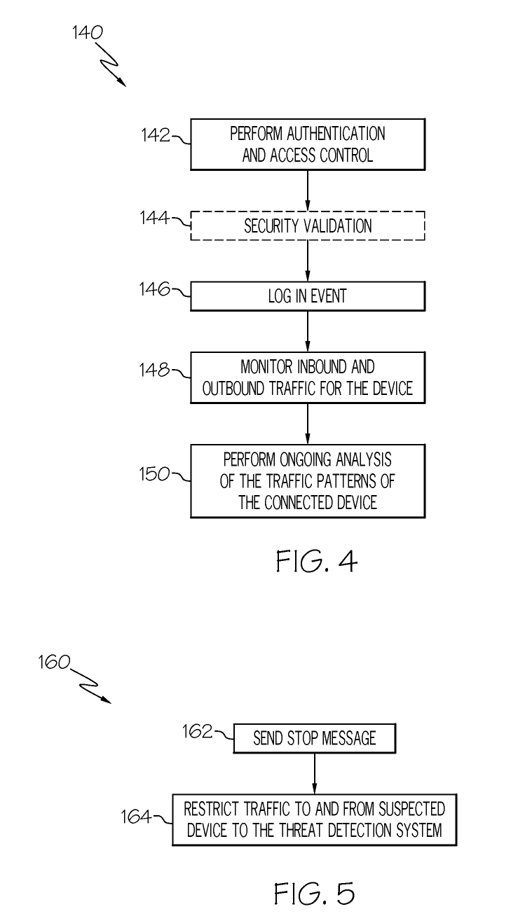

Referring to FIG. 4, an exemplary method 140 is illustrated for performing the authentication and monitoring of a connected processing device at 112 described with reference to FIG. 2, which may further be implemented by the threat, detection system 130 described with reference to FIG. 3. According to an aspect of the present invention, a conventional authentication and/or access control process is performed at 142, e.g., to log or otherwise connect a device onto the network. The authentication and access control may also optionally be augmented, with security validation of the device at 144. Corresponding to connecting the device to the network, the threat detection system receives a login event at 146, e.g., to appraise the threat analysis component 134 of the threat detection system 130 of the new connection. In response to receiving the login event, the threat analysis component 134 begins monitoring inbound and outbound traffic for the connected processing device at 148. The threat analysis component 134 performs ongoing analysis of the traffic patterns of the connected processing device at 150. For example, the threat analysis component 134 described with reference to FIG. 3 may comprise an analysis engine that utilizes adaptive techniques which will be described in greater detail herein to analyze traffic patterns of the connected device(s).

Referring to FIG. 5, a method 160 illustrates an exemplary interaction between the authentication/access control component 132 and the threat analysis component 134 to place a connected processing device 102B into quarantine. The threat analysis component 134 sends a stop message to the authentication/access control component at 162 if the threat analysis component 134 recognizes a pattern of traffic that it believes to be indicative of a compromised device. In response to receiving the stop message, the authentication/access control component 132 utilizes its restriction module 136 to deploy a filter, or otherwise utilizes a suitable technique to restrict traffic on the suspected comprised processing device to a single “restricted access” channel at 164. Restriction of the processing device to a single channel of communication e.g., using the restriction module 136 is an example of quarantining a connected processing device so as to limit communication of the quarantined processing device to the components of the threat detection system 130.

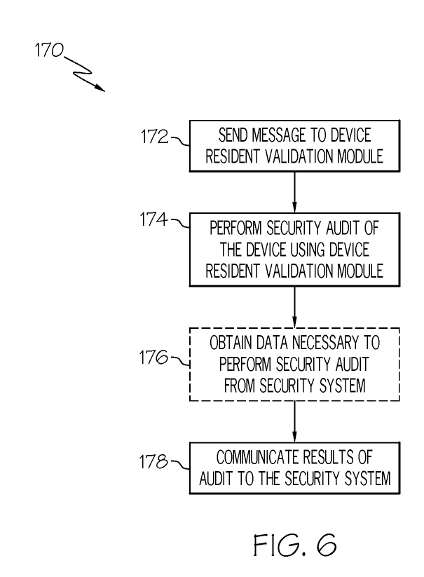

Referring to FIG. 6, a method 170 illustrates an example of performing a security check on a quarantined processing device 102C. The threat detection system 130 sends a message through the restricted access channel to the device resident security validation component 138 on the quarantined processing device at 172. In response to the message, the device resident security validation component 138 performs a security audit of its corresponding device at 174 and communicates the results back to the threat detection system 130. The exchange between the threat detection system 130 and the device resident security validation component 138 is directed to determine whether or not the quarantined processing device 102C is actually compromised. In this regard, the device resident security validation component 138 may need to obtain data necessary to perform its security audit from the threat detection system at 176. For example, necessary data that is not locally available to the device resident security validation component 138, such as virus definitions, etc., may be obtained from the threat detection system 130 in order to make an appropriate threat audit or other threat related determination.

The device resident security validation component 138 sends the audit results to the threat detection system at 178. Based on the results from the device resident security validation component 138, the threat detection system 130 sends a message to the authentication/access control component 132 telling it to either lift the restrictions on the corresponding quarantined processing device 102C, or to take some other action on the quarantined processing device 102C, such as by disconnecting the quarantined processing device 102C from the network, etc. When the quarantined processing device 102C disconnects, a stop event may be sent from the authentication/access control component 132 to the threat analysis component 134. Other exemplary actions may comprise cleaning or otherwise removing a virus from the infected device or taking other appropriate action to remove detected malware, etc., as described in greater detail herein.

The threat detection system 130 now has empirical evidence from the device resident security validation component 138 as to whether its classification of the quarantined processing device 102 as being “compromised” was correct. This feedback may be processed to improve a classification algorithm used to identify connected processing devices 102B that may be suspected of being compromised.

According to an aspect of the present invention, the threat analysis component 134 may make use of the traffic patterns observed during the “uninfected” portions of device connections in combination with the audit data from device resident security validation components 138 of corresponding quarantined processing devices 102C to improve its analysis capabilities. For example, the threat analysis component 134 may collect historical information about the traffic patterns of connected devices 102B. Historical information may be collected by observing each connection and maintaining a sliding window that contains data for a discrete unit of time. At a fixed interval, each window is updated and then analyzed, e.g., using neural network techniques such as a Hopfield network or self-organizing map, or by using Bayesian and/or other statistical techniques.

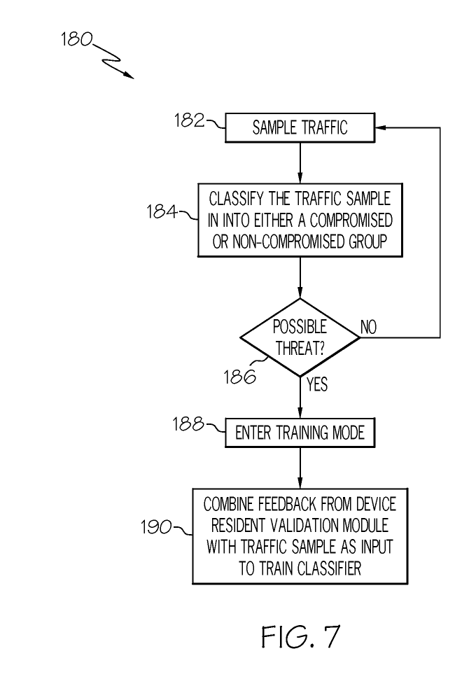

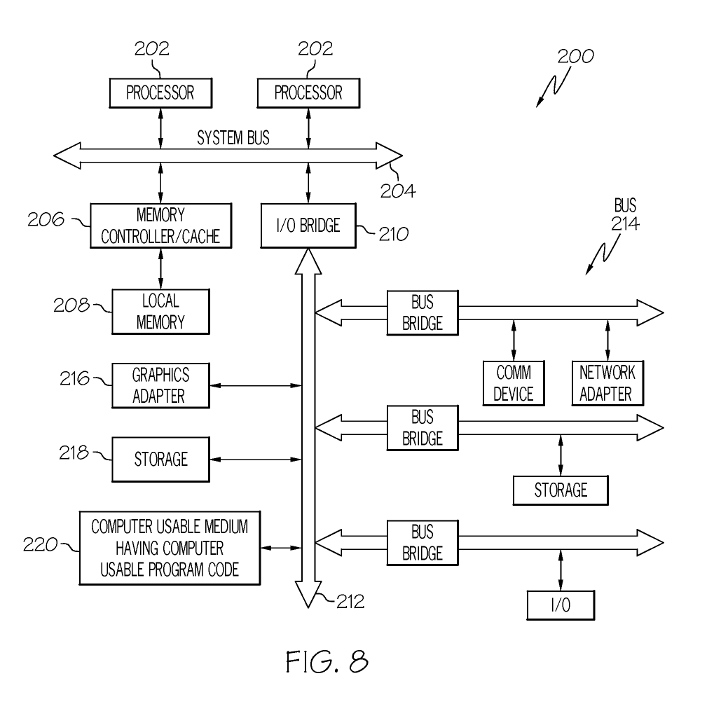

Referring to FIG. 7, a method 180 illustrates an exemplary approach for dynamically training the threat detection system according to an aspect of the present invention. The threat detection system samples traffic from connected devices at 182, e.g., using the sliding window technique discussed above. As an example, the threat analysis component 134 may implement a neural network approach that uses pattern recognition to classify the traffic samples in each sliding window (corresponding to a connected device 102B) into either a compromised or non-compromised group at 184. A decision is made at 186 as to whether any of the connected devices 102B pose a potential threat to the network. For example, the decision may be based upon whether any of the traffic samples were classified into the compromised group. If no traffic samples were classified into the compromised group, then flow loops to 182 to continue to collect and analyze traffic samples. If a threat is detected at 186, then appropriate quarantine and action are carried out as described in greater detail herein.

Further, for devices which are placed into the compromised group, i.e., quarantined processing devices 102C, the threat analysis system may enter a training mode at 188 in which the threat detection system 130 combines the feedback from a corresponding device resident security validation component 138, e.g., as obtained during the quarantine process, with the data in one or more traffic samples as input to adjust the connection weights in its neural network at 190. This enables the threat detection system 130 to “learn” from the traffic patterns of the quarantined device. The threat detection system 130 can also use other parameters, such as traffic patterns of other non quarantined devices to adjust the weights in its neural network. Still further, the neural network can learn in other additional ways.

The autonomic learning of the threat detection system 130 may be augmented by operator assisted learning. For example, a network administrator may manually flag devices or patterns which should (or should not) be quarantined. Thus, for example, the autonomic learning capability of the threat detection system does not need to start off without a base of knowledge, but rather may be seeded with log data that has been analyzed by a development lab or is otherwise known to a network administrator.

According to aspects of the present invention, the threat detection system has the ability to dynamically adjust the threat detection criteria based on observed changes in the behavior of connected devices. That is, the baseline behaviors that are being compared against by the threat detection system 130 can be changed over time by “training” the artificial neural network model using data about the behaviors and threat classification of connected devices. Thus, static heuristic rules or other static, operator determined rules, which are based on information about previous suspicious behavior, which may be used to “pre-program” or otherwise augment the threat detection system knowledge can be autonomically changed, revised, expanded, discarded, etc.

In this way, training data is collected so that the behavior of the classification system, e.g., the neural network, used by the threat detection system 130 can be updated without requiring a human operator to actually analyze the historical information by hand and try to develop heuristics. The overall system allows the neural network to do this itself, although the networks own learning could also be augmented with human analyzed training data as noted above.

In practice, there may be multiple access points to a particular implementation of a network computing environment. As such, the threat detection system 130 may monitor multiple access points, e.g., by implementing multiple authentication/access control components 132 or multiple instances of the threat detection system 130 may be deployed across the network 104 to provide threat mitigation at desired points of access to the network.

Referring to FIG. 8, a block diagram of a data processing system is depicted in accordance with the present invention. Data processing system 200, such as one of the processing devices 102 described with reference to FIGS. 1 and 3, may comprise a symmetric multiprocessor (SMP) system or other configuration including a plurality of processors 202 connected to system bus 204. Alternatively, a single processor 202 may be employed. Also connected to system bus 204 is memory controller/cache 206, which provides an interface to local memory 208. An I/O bus bridge 210 is connected to the system bus 204 and provides an interface to an I/O bus 212. The I/O bus may be utilized to support one or more busses and corresponding devices 214, such as bus bridges, input output devices (I/O devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 216, storage 218 and a computer usable storage medium 220 having computer usable program code embodied thereon. The computer usable program code may be executed to execute any aspect of the present invention, for example, to implement any aspect of any of the methods illustrated in FIGS. 2 and 4-7. In the case of a network side server, the computer usable program code may be executed to implement the authentication/access control component 132, including the restriction module 136. In the case of a network side server, the computer usable program code may also be executed to implement the threat analysis component 134 including any required threat analysis engine features, such as the artificial neural network and other processes performed thereby. In the case of a connected device, the computer usable program code may be executed to implement the device resident security validation component 138, etc.

The data processing system depicted in FIG. 8 may be, for example, an IBM RS/6000 system, a product of International Business Machines Corporation in Armonk, N.Y., running the Advanced Interactive Executive (AIX) operating system. An object oriented programming system such as Java may run in conjunction with the operating system and provides calls to the operating system from Java programs or applications executing on data processing system.

The various aspects of the present invention may be embodied as systems, computer-implemented methods and computer program products. Also, various aspects of the present invention may take the form of an entirely hardware embodiment, an entirely software embodiment (including software, firmware, micro-code, etc.) or an embodiment combining software and hardware, wherein the embodiment or aspects thereof may be generally referred to as a “circuit,” “component” or “system.” Furthermore, the various aspects of the present invention may take the form of a computer program product on a computer-usable storage medium having computer-usable program code embodied in the medium or a computer program product accessible from a computer-usable or computer-readable medium providing program code for use by or in connection with a computer or any instruction execution system.

The software aspects of the present invention may be stored, implemented and/or distributed on any suitable computer usable or computer readable medium(s). For the purposes of this description, a computer-usable or computer readable medium can be any apparatus that can contain, store, communicate, propagate, or transport the program for use by or in connection with the instruction execution system, apparatus, or device. The computer program product aspects of the present invention may have computer usable or computer readable program code portions thereof which are stored together or distributed, either spatially or temporally across one or more devices. A computer-usable or computer-readable medium may comprise, for example, an electronic, magnetic, optical, electromagnetic, infrared, or semiconductor system, apparatus, device, or propagation medium. As yet further examples, a computer usable or computer readable medium may comprise cache or other memory in a network processing device or group of networked processing devices such that one or more processing devices stores at least a portion of the computer program product. The computer-usable or computer-readable medium may also comprise a computer network itself as the computer program product moves from buffer to buffer propagating through the network. As such, any physical memory associated with part of a network or network component can constitute a computer readable medium.

More specific examples of the computer usable or computer readable medium comprise for example, a semiconductor or solid state memory, magnetic tape, an electrical connection having one or more wires, a swappable intermediate storage medium such as floppy drive or other removable computer diskette, tape drive, external hard drive, a portable computer diskette, a hard disk, a rigid magnetic disk, a random access memory (RAM), a read-only memory (ROM), an erasable programmable read-only memory (EPROM or Flash memory), a portable compact disc read-only memory (CD-ROM), a read/write (CD-R/W) or digital video disk (DVD), an optical fiber, disk or storage device, or a transmission media such as those supporting the Internet or an intranet. The computer-usable or computer-readable medium may also comprise paper or another suitable medium upon which the program is printed or otherwise encoded, as the program can be captured, for example, via optical scanning of the program on the paper or other medium, then compiled, interpreted, or otherwise processed in a suitable manner, if necessary, and then stored in a computer memory. The computer-usable medium may include a propagated data signal with the computer-usable program code embodied therewith, either in baseband or as part of a carrier wave or a carrier signal. The computer usable program code may also be transmitted using any appropriate medium, including but not limited to the Internet, wire line, wireless, optical fiber cable, RF, etc.

Computer program code for carrying out operations of the present invention may be written in any suitable language, including for example, an object oriented programming language such as Java, Smalltalk, C++ or the like. The computer program code for carrying out operations of the present invention may also be written in conventional procedural programming languages, such as the “C” programming language, or in higher or lower level programming languages. The program code may execute entirely on a single processing device, partly on one or more different processing devices, as a stand-alone software package or as part of a larger system, partly on a local processing device and partly on a remote processing device or entirely on the remote processing device. In the latter scenario, the remote processing device may be connected to the local processing device through a network such as a local area network (LAN) or a wide area network (WAN), or the connection may be made to an external processing device, for example, through the Internet using an Internet Service Provider.

The present invention is described with reference to flowchart illustrations and/or block diagrams of methods, apparatus systems and computer program products according to embodiments of the invention. It will be understood that each block of the flowchart illustrations and/or block diagrams, and combinations of blocks in the flowchart illustrations and/or block diagrams may be implemented by system components or computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention may be practiced on any form of computer system, including a stand alone computer or one or more processors participating on a distributed network of computers. Thus, computer systems programmed with instructions embodying the methods and/or systems disclosed herein, or computer systems programmed to perform various aspects of the present invention and storage or storing media that store computer readable instructions for converting a general purpose computer into a system based upon the various aspects of the present invention disclosed herein, are also considered to be within the scope of the present invention. Once a computer is programmed to implement the various aspects of the present invention, including the methods of use as set out herein, such computer in effect, becomes a special purpose computer particular to the methods and program structures of this invention. The techniques necessary for this are well known to those skilled in the art of computer systems.

The flowchart and block diagrams in the Figures illustrate the architecture, functionality, and operation of possible implementations of systems, methods and computer program products according to various embodiments of the present invention. In this regard, one or more blocks in the flowchart or block diagrams may represent a component, segment, or portion of code, which comprises one or more executable instructions for implementing the specified logical function(s). In some alternative implementations, the functions noted in the blocks may occur out of the order noted in the figures. For example, two blocks shown in succession may, in fact, be executed substantially concurrently or in the reverse order.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

Having thus described the invention of the present application in detail and by reference to embodiments thereof, it will be apparent that modifications and variations are possible without departing from the scope of the invention defined in the appended claims.

What is claimed is:

1. A method of performing autonomic threat detection comprising:
collecting traffic samples of traffic patterns associated with a device having a device resident validation module, which is connected to a network;
using a threat analysis system to recognize a pattern of traffic based at least in part upon said traffic samples, where said pattern of traffic is determined to be indicative of a compromised device;
performing a quarantine of said device if determined to be a compromised device;
performing a security check on said device if said device has been quarantined comprising:
requesting data from said device resident validation module to determine if said device is compromised;
analyzing data from said device resident validation module of said quarantined device, and
taking an action based upon analysis of said data; and
utilizing at least one of said data from said device resident validation module of said quarantined device or said traffic samples to autonomically train said threat analysis system to identify compromised devices.

2. The method according to claim 1, wherein said performing a quarantine of said device if determined to be a compromised device comprises:
enabling communication between said device and said threat analysis system and disabling communication between said device and other non-threat related components of said system.

3. The method according to claim 2, wherein said enabling communication between said device and a threat analysis system and disabling communication between said device and other non-threat related components of said system comprises:
utilizing a filter to restrict communication of said device to said threat analysis system.

4. The method according to claim 1, wherein said using a threat analysis system to recognize a pattern of traffic based at least in part upon said traffic samples, where said pattern of traffic is determined to be indicative of a compromised device comprises:
using a threat classifier to classify said traffic samples into either a compromised group or non-compromised group.

5. The method according to claim 4, wherein:
said using a threat classifier to classify said traffic samples into either a compromised group or non-compromised group comprises using an artificial neural network or other adaptive analysis algorithm to compare said traffic samples against baseline behaviors; and
said utilizing at least one of said data from said device resident validation module of said quarantined device and said traffic samples to autonomically train said threat analysis system to identify compromised devices comprises training said threat classifier by automatically updating baseline behaviors.

6. The method according to claim 1, wherein said collecting traffic samples of traffic patterns associated with a device having a device resident validation module, which is connected to a network comprises:
observing a connection between said device and said system;
maintaining a sliding window which contains data for a discrete unit of time; and
updating said window at a fixed interval.

7. The method according to claim 1, wherein said taking an action based upon analysis of said data comprises at least one of lifting said device from quarantine and disconnecting said device from said system.

8. A computer program product to perform autonomic threat detection comprising:
a computer usable medium having computer usable program code embodied therewith, the computer usable program code comprising;
computer usable program code configured to collect traffic samples of traffic patterns associated with a device having a device resident validation module, which is connected to a network;
computer usable program code configured to implement a threat analysis system to recognize a pattern of traffic based at least in part upon said traffic samples, where said pattern of traffic is determined to be indicative of a compromised device;
computer usable program code configured to perform a quarantine of said device if determined to be a compromised device;
computer usable program code configured to perform a security check on said device if said device has been quarantined comprising:
computer usable program code configured to request data from said device resident validation module to determine if said device is compromised;
computer usable program code configured to analyze data from said device resident validation module of said quarantined device; and
computer usable program code configured to take an action based upon analysis of said data; and
computer usable program code configured to utilize at least one of said data from said device resident validation module of said quarantined device or said traffic samples to autonomically train said threat analysis system to identify compromised devices.

9. The computer program product according to claim 8, wherein said computer usable program code configured to perform a quarantine of said device if determined to be a compromised device comprises:
computer usable program code configured to enable communication between said device and said threat analysis system and disabling communication between said device and other non-threat related components of said system.

10. The computer program product according to claim 9, wherein said computer usable program code configured to enable communication between said device and a threat analysis system and disabling communication between said device and other non-threat related components of said system comprises:
computer usable program code configured to implement a filter to restrict communication of said device to said threat analysis system.

11. The computer program product according to claim 8, wherein said computer usable program code configured to implement a threat analysis system to recognize a pattern of traffic based at least in part upon said traffic samples, where said pattern of traffic is determined to be indicative of a compromised device comprises:
computer usable program code configured to implement a threat classifier to classify said traffic samples into either a compromised group or non-compromised group.

12. The computer program product according to claim 11, wherein:
said computer usable program code configured to implement a threat classifier to classify said traffic samples into either a compromised group or non-compromised group comprises:
computer usable program code configured to implement an artificial neural network or other adaptive analysis algorithm to compare said traffic samples against baseline behaviors; and
said computer usable program code configured to utilize at least one of said data from said device resident validation module of said quarantined device or said traffic samples to autonomically train said threat analysis system to identify compromised devices comprises:
computer usable program code configured to train said threat classifier by automatically updating said baseline behaviors.

13. The computer program product according to claim 8, wherein said computer usable program code configured to collect traffic samples of traffic patterns associated with a device having a device resident validation module, which is connected to a network comprises;
computer usable program code configured to observe a connection between said device and said system;
computer usable program code configured to maintain a sliding window which contains data for a discrete unit of time; and
computer usable program code configured to update said window at a fixed interval.

14. The computer program product according to claim 8, wherein said computer usable program code configured to take an action based upon analysis of said data comprises:
computer usable program code configured to perform at least one of lifting said device from quarantine and disconnecting said device from said system.

15. A system to perform autonomic threat detection comprising:
a threat analysis component that is configured to collect traffic samples of traffic patterns associated with a device having a device resident validation module, which is connected to a network, said threat analysis component further configured to recognize a pattern of traffic based at least in part upon said traffic samples, where said pattern of traffic is determined to be indicative of a compromised device, wherein said threat analysis component is further configured to:
communicate a message to said authentication and access control component to perform a quarantine of said device if determined to be a compromised device;
perform a security check if said device is quarantined, wherein said threat analysis component requests data from said device resident validation module of said quarantined device to determine if said device is compromised, analyzes data from said device resident validation module of said quarantined device, takes an action based upon analysis of said data, and utilizes at least one of said data from said device resident validation module of said quarantined device or said traffic samples to autonomically train said threat analysis system to identify compromised devices.

16. The system according to claim 15, wherein said authentication and access control component is further configured to enable communication between said device and said threat analysis system and disable communication between said device and other non-threat related components of said system.

17. The system according to claim 16, wherein said wherein said authentication and access control component utilizes a filter to restrict communication of said device to said threat analysis system.

18. The system according to claim 15, wherein said threat analysis component utilizes a threat classifier to classify said traffic samples into either a compromised group or non-compromised group.

19. The system according to claim 18, wherein said threat classifier is implemented using an artificial neural network or other adaptive analysis algorithm to compare said traffic samples against baseline behaviors and said threat analysis system updates said baseline behaviors to autonomically train said threat classifier.

20. The system according to claim 15, wherein said threat analysis component is further configured to observe a connection between said device and said system, maintain a sliding window which contains data for a discrete unit of time and update said window at a fixed interval.

21. The system according to claim 15, wherein said action based upon analysis of said data comprises at least one of lifting said device from quarantine and disconnecting said device from said system.
